(19) United States
(12) Patent Application Publication
(10) Pub. No.: US 2004/0195789 A1
(43) Pub. Date: Oct. 7, 2004

(54) Load carrying and lifting apparatus

(76) Inventor: Louis S. Christensen, Pasadena, CA (US)

Correspondence Address: Boniard I. Brown, 1500 West Covina Parkway, #113, West Covina, CA, 91790-2793, US

(21) Appl. No.: 10/817,672

(22) Filed: Apr. 2, 2004

Related U.S. Application Data
(60) Provisional application No. 60/460,637, filed on Apr. 4, 2003.

(51) Int. Cl. B62B 1/00

(52) U.S. Cl. 280/35

(57) ABSTRACT

A load carrying apparatus is supported on wheels and has a load-bearing member which is raised or lowered by a gear system operating a lead screw to raise and lower a load. Ground wheels are disposed on retractable arms to enable passage through restricted spaces and doorways.

### RELATED APPLICATIONS

Reference is made to my Provisional Application No. 60/460,637, filed Apr. 4, 2003.

### BACKGROUND AND FIELD OF INVENTION

The handling of relatively heavy items or equipment, such as motion picture lighting and camera equipment, medical equipment or other relatively heavy items, has long been characterized by problems including awkward handling, heavy manual lifting, and inability or difficulty in passing equipment through relatively narrow spaces such as doorways.

The present invention addresses such problems by a carrier apparatus capable of lifting and moving substantially heavy objects. The equipment has a special gearing system arrangement for raising and lowering a load, which is relatively easy to operate.

Effective and easily operable means are provided for the raising and lowering of a load-bearing member by means of a lead screw operated by a gearing system having a socket portion adapted to receive and retain a load.

A plurality of leg members are pivotalluy mounted and retractable to enable passage of the equipment through restricted spaces or doorways.

### BRIEF DESCRIPTION OF THE DRAWINGS

FIG. 1 is a perspective view of a preferred embodiment of the present invention;

FIG. 2 is a perspective view of the embodiment of FIG. 1 showing extending arms thereof in retracted positions;

FIG. 3 is a top view of the embodiment shown in FIG. 1;

FIG. 4 is a sectional view taken at line 4-4 in FIG. 9;

FIG. 5 is a partial view of the embodiment of FIGS. 1 and 2 showing arm members thereof in retracted positions;

FIG. 6 is a partial view of the embodiment of FIGS. 1 and 2 showing arm members thereof in extended positions;

FIG. 7 is a sectional view taken at line 7-7 in FIG. 6;

FIG. 8 is a sectional view taken at line 8-8 in FIG. 7;

FIG. 9 is an elevational sectional view taken at line 9-9 in FIG. 1;

FIG. 10 is an elevational view similar to that of FIG. 9, showing movable components in different positions;

FIG. 11 is a sectional view, similar to those of FIGS. 9 and 10, showing movable components thereof in different positions;

FIG. 12 is a sectional view taken at line 12-12 in FIG. 9;

FIG. 13 is a sectional view taken at line 13-13 in FIG. 11; and

FIG. 14 is a sectional view taken at line 14-14 in FIG. 11.

### DESCRIPTION OF A PREFERRED EMBODIMENT

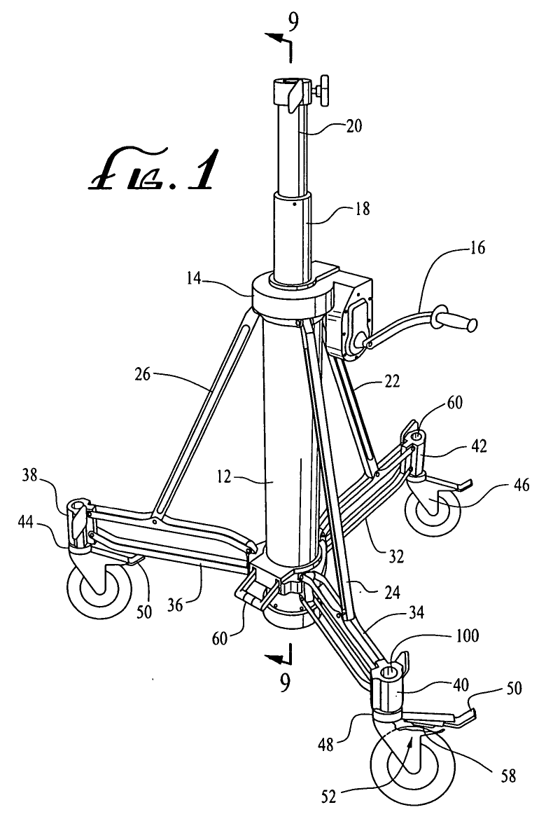

Referring to the drawings, particularly to FIGS. 1, 2 and 3, a preferred embodiment of the present invention 10 has a central cylindrical housing 12, a gear housing 14, a manual crank 16 mounted on the gear housing 14, and tubular members 18, 20 extending upwardly in telescoping relation. Tubular member 18 supports a socket member 19 at its upper end portion to receive a load.

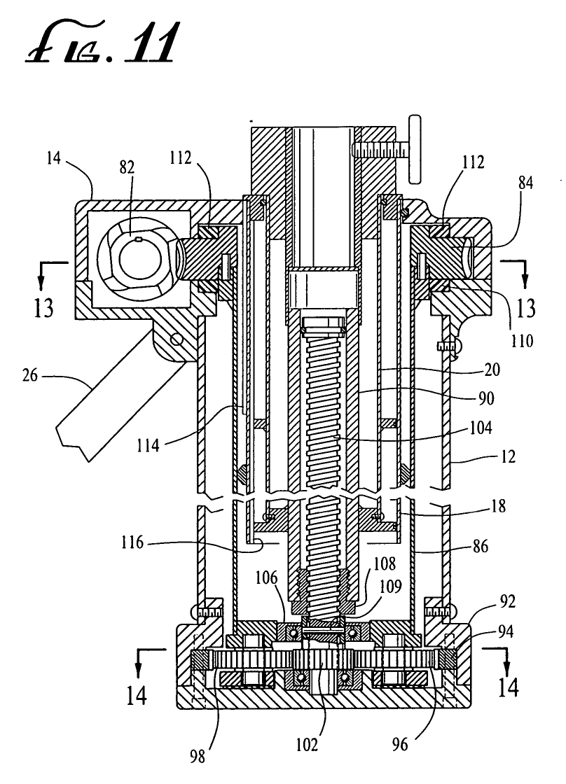

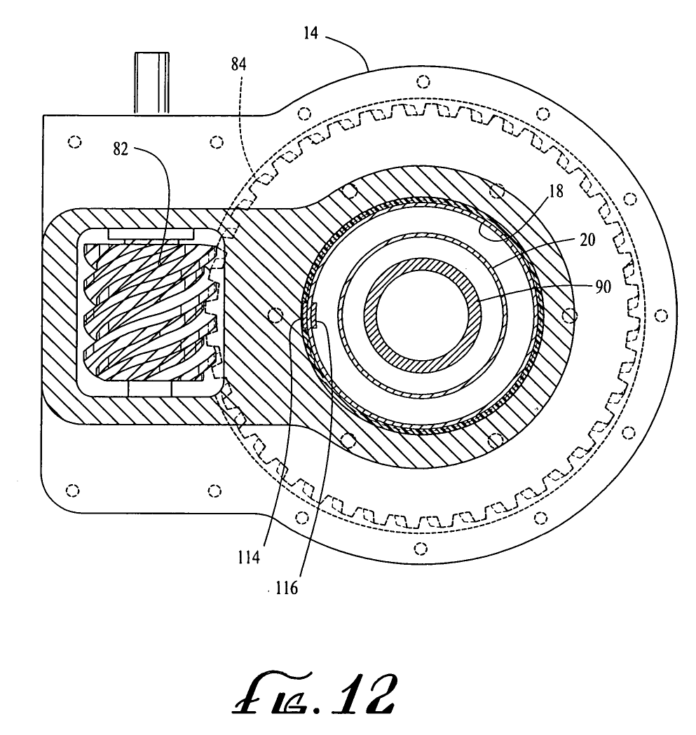

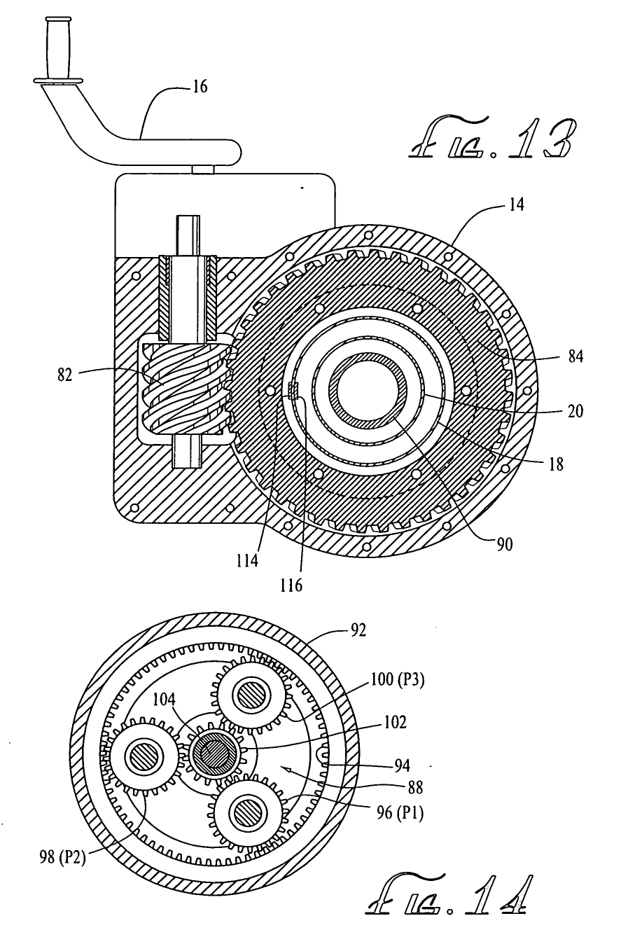

Socket member 19 is secured, as by welding, to tubular member 20 and is slidable relative to tubular member 18 via the sealing member shown. FIGS. 9, 10 and 11 show different positions of member 90 and the structure thereon, effected by lead screw 1.04 rotation by action of the rotation of the sun gear 102 rotated by the gear system of the apparatus. FIG. 9 shows the tubes 20 and 90 fully extended upwardly, FIG. 10 showing them in intermediate position, and FIG. 11 showing the members 20 and 90 in their lowermost positions, with the lead screw 104 fully extended in tube 90.

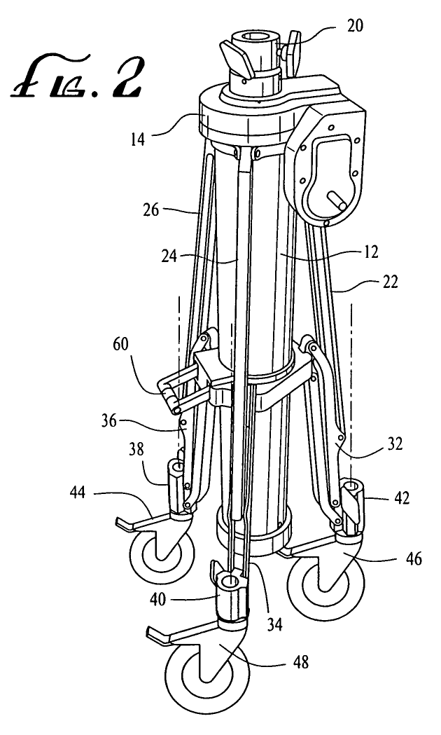

Legs 22, 24, 26 extend radially outwardly and downwardly and have their outer end portions pivotally connected respectively at tipper members of respective parallelogram mechanisms 32, 34 and 36, as shown. Upper and lower members of each of the parallelogram mechanisms are pivotally attached to respective socket members 38, 40, 42 of respective casters or wheel assemblies 44, 46, 48 as shown in FIGS. 1 and 2. The respective socket members are adapted to receive pin members on relatively heavy loads for carriage by the apparatus of the invention, such as heavy motion picture lighting equipment, cameras, medical equipment, etc. An appropriate pin (not shown) enables the towing of substantial loads by a cable of line from the pin to a load-bearing wagon or cart.

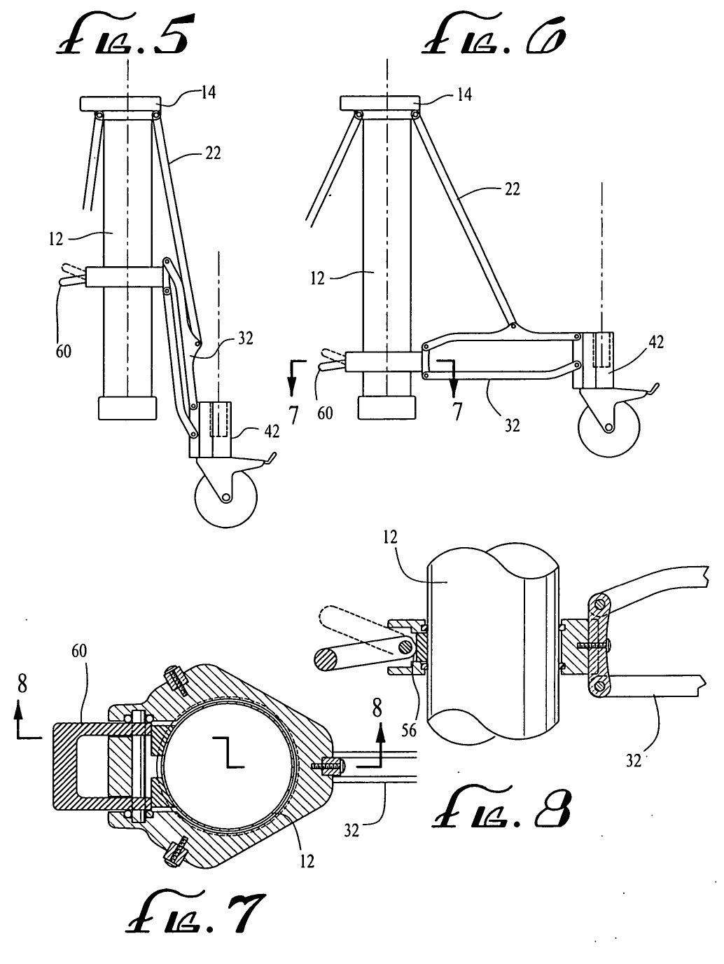

Referring to FIGS. 5 and 6, there is shown the manner in which each respective parallelogram mechanism 32, 34, 36 maintains the axis of an associated wheel assembly in vertical relation to a supporting surface or floor, and parallel to the axis of housing 12. Such parallelogram mechanisms are known in the art and are employed advantageously with the apparatus of the present invention.

The casters or wheel assemblies each have a brake mechanism comprising a foot pedal 50, a leverage mechanism (not shown), a tire engaging member, and a braking mechanism 52 (not shown). Foot operation of the braking mechanism urges a braking member 56 to effect firm braking action, and can effect operation of another member (not shown) to prevent pivoting of a caster relative to its axis.

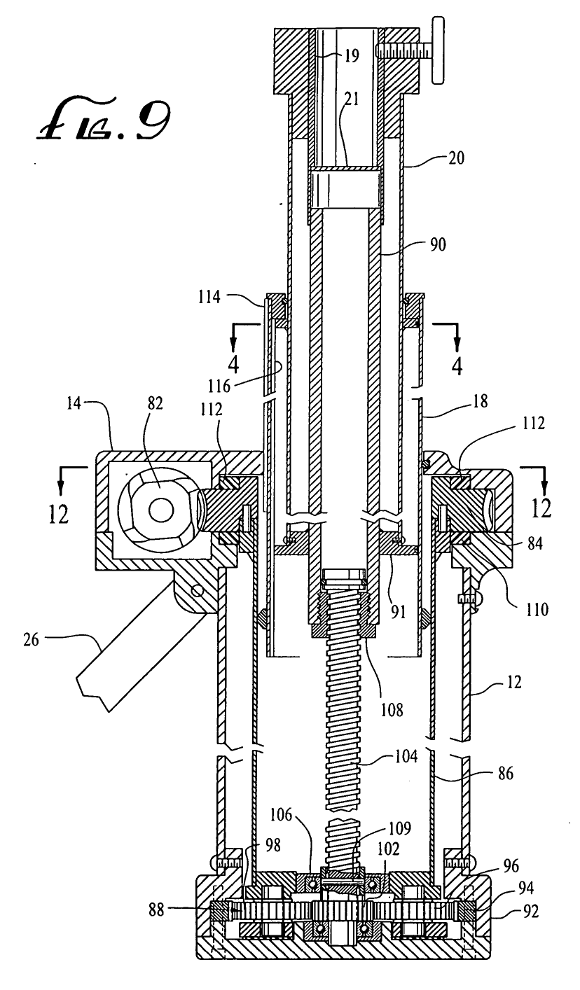

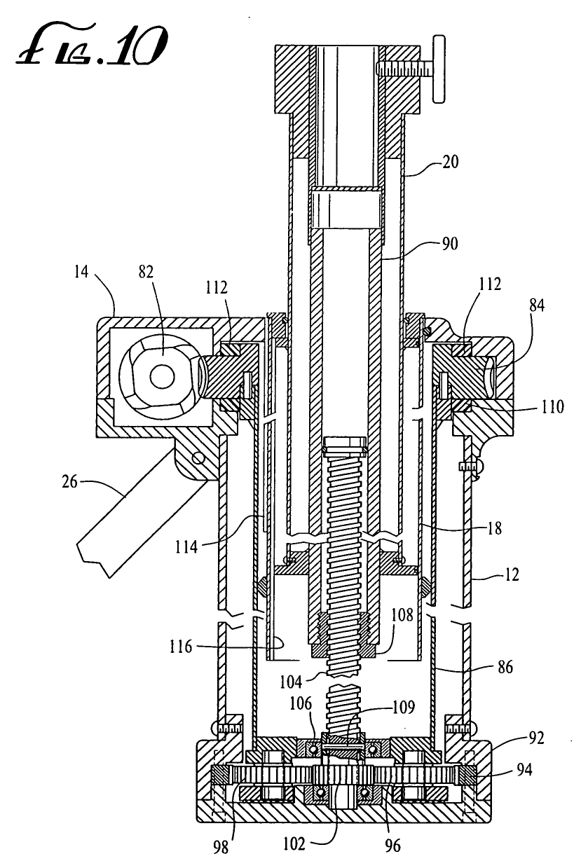

Referring to FIGS. 1, 7 and 8, a manual clamp handle 60 is operable to urge a braking cam portion 56 (FIG. 8) to secure the parallelogram mechanisms in selected position on housing 12 and to stabilize the apparatus.

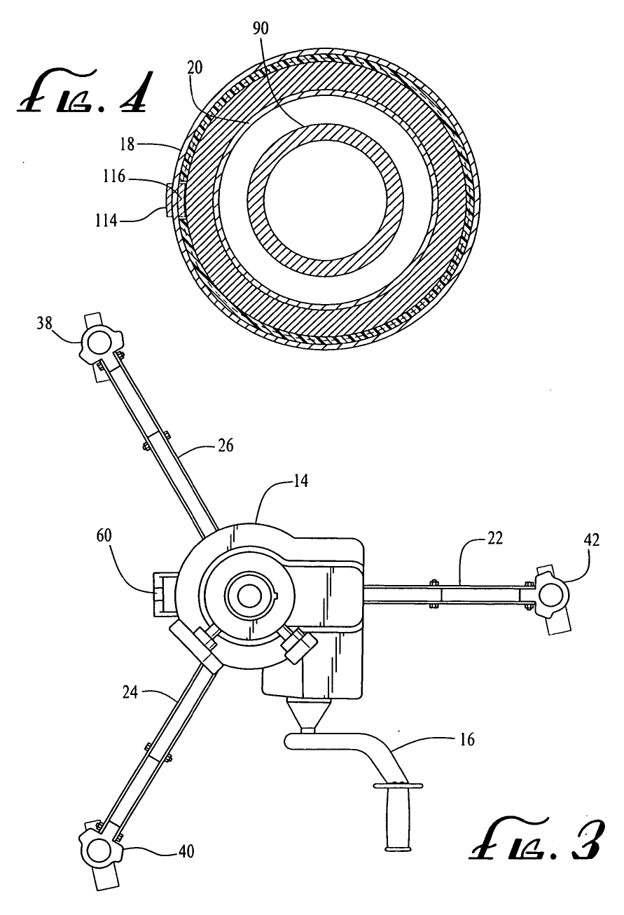

Referring to FIG. 9, which is a sectional view taken at line 9-9 in FIG. 1, and to FIGS. 4 and 12, which are sectional views taken in FIG. 9, outer tubular housing 12 is secured to the gear housing and to a bottom member or housing 92 by threaded fasteners, as shown.

The gear housing 14 and bottom member 92 contain a gearing system operable for the raising and lowering of a load-carrying central tubular member 90 with a load (not shown) thereon.

Manual rotation of the crank 16 (FIG. 1) rotates a worm gear 82 (FIG. 9) having a spiral thread which engages a ring gear 84, as shown, and bearingly mounted in gear housing 14, as shown, and secured and pinned relative to a transfer tube 86. The rotary motion applied to transfer tube 86 is applied to a gear assembly 88 via pins 89 in a bottom or base member 92, which is secured to outer housing 12, as shown. Gear assembly 88 is rotated via tube 86 by the ring gear 84 which is secured to tube 86. The gear assembly in the bottom member 92 comprises a stationary large diameter ring gear 94 defined in the base member 92, three planetary gears 96, 98, 100, (P1, P2, P3), shown in FIG. 14, and a central sun gear 102. The planetary gears are rotated by the tube 86 and by their engagements with stationary ring gear 92. The central sun gear 102 is secured by pin 109 and mounting assembly 106. As shown, the central sun gear is rotated by the planetary gears. The sun gear thus rotates the lead screw 104.

FIGS. 9, 10 and 11 show certain positions in which tube 20 may be disposed by operation of the lead screw 104. Member 108 is threaded into the lower end portion of tube 90 so that rotation of the lead screw 104 raises or lowers the load-bearing tubular members 20 and 90. Rotation of the lead screw 104 operates to raise or lower the load-bearing tube 90, depending upon direction of the lead screw. The load-carrying member 90 is shown extended fully upwardly in FIG. 9 with housing 18 extended fully upwardly. FIG. 10 shows a load-carrying member 90 in a lower position and the outer member 18 lowered. In FIG. 11 load-carrying member 90 is in its lowermost position with its outwardly extended upper portions seated on members atop housing 18.

Bushings 110, 112 serve to prevent or minimize vibration as between ring gear 84 and lead screw 104, and to stabilize the arrangement.

The member 108 must be prevented from rotation because this could prevent raising or lowering the tube 90. Tube 90 is prevented from axial rotation by a strip member 116 disposed in a keyway (not shown) in the interior wall of tube 18, and in a slot (not shown) in an annular member 91, which engages the inner wall of tube 18, as shown, and is secured by threaded fasteners to tube 90. A strip member 114 engages in a notch or groove (not shown) in an adjacent portion of gear housing 14 to prevent rotation of tube 18, and engages in a groove (not shown) in member 91. Engagement of the strip members 114, 116 in these grooves prevents rotation of tube 90.

It will be understood that various changes and modifications may be made from the preferred embodiments discussed above without departing from the scope of the present invention, which is established by the following claims and equivalents thereof.

1. A load carrying apparatus comprising:
housing means supported on wheels,
a load-bearing member in said housing means and movable vertically relative thereto, and
gear means for raising and lowering the load-bearing member, said gear means comprising a gear train arrangement to operate a lead screw to raise and lower the load-bearing member.

2. An apparatus according to claim 1, wherein said load-bearing member defines a socket to receive a load.

3. An apparatus according to claim 1, wherein the gear means comprises a worm gear which is manually operable to operate a gear-train system to raise and lower the load-bearing member.

4. An apparatus according to claim 1, wherein the direction of rotation of the lead screw determines the raising or lowering of the load-bearing member.

5. An apparatus according to claim 1, wherein said wheels comprise pivotable casters.

6. A load carrying apparatus comprising:
housing means supported on wheels,
a load bearing member mounted for vertical movement relative to the housing, and
gear means comprising an externally operated operable worm gear, a ring gear driven by the worm gear and connected with lower planetary gears to rotate a sun gear attached to a lead screw to rotate the lead screw to raise and lower said load-bearing member in accordance with the direction of rotation of the lead screw.

7. An apparatus according to claim 6, wherein said wheels comprise pivotable casters.

8. An apparatus according to claim 6, wherein said wheels are disposed on respective arms pivotally mounted on said housing,
said arms being pivotally retractable to enable the apparatus to pass through restricted spaces and doors.

9. An apparatus according to claim 6, wherein said gear means comprises planetary gears rotated by tubular means connected with the ring gear to rotate a sun gear affixed to said lead screw.

10. Apparatus according to claim 6 and comprising a plurality of leg members pivotally mounted on the housing and being retractable to enable the apparatus to pass through restricted spaces and doors,
said wheels being disposed on outer portions of respective leg members.

11. A load carrying apparatus comprising:
housing means supported on wheels,
a load-bearing member in said housing means and movable vertically relative thereto, and
wherein the generally tubular member generally coaxial with the lead screw rotates planetary gears rotatable relative to a fixed ring gear in the lower portion of said housing means to rotate a sun gear connected with said lead screw to raise or lower said load-bearing member in accordance with the direction of rotation of the lead screw.

12. An apparatus according to claim 6 and further comprising a crank arm manually operable to rotate said worm gear to rotate a ring gear secured to a generally tubular member secured to said ring gear to rotate the planetary gears lower in the housing means to rotate a sun gear and the lead screw.

13. An apparatus according to claim 11, wherein an elongated tube extends between the ring gear and a base portion of said housing to rotate one planetary gear to rotate a sun gear affixed to the lead screw.

14. An apparatus according to claim 11, and further comprising a parallelogram mechanism on at least one of said legs and disposed between said leg and one of said wheels to maintain the wheels in generally vertical orientation with its axis horizontal.

15. An apparatus according to claim 11, wherein each of said wheels is a component of a pivotally mounted caster.

16. An apparatus according to claim 11, and further comprising foot-operated brake means on a plurality of said wheels.

17. An apparatus according to claim 16, wherein said brake means comprises a foot-operated pedal to urge a braking member against said wheels.

18. An apparatus according to claim 11, and comprising a plurality of leg members pivotally mounted on the housing and being retractable to enable the apparatus to pass through restricted spaces and doors,
said wheels being disposed on outer portions of respective leg members.

19. An apparatus according to claim 11, and further comprising a crank arm manually operable to rotate said worm gear to rotate a ring gear secured to a generally tubular member secured to said ring gear to rotate the planetary gears lower in the housing means to rotate a sun gear and the lead screw.
